(19) United States
(12) Patent Application Publication
(10) Pub. No.: US 2022/0019274 A1
(43) Pub. Date: Jan. 20, 2022

(54) POWER CONTROL BASED ON CUMULATIVE ERROR

(71) Applicant: Hewlett-Packard Development Company, L.P., Spring, TX (US)

(72) Inventors: Robert Yraceburu, Vancouver, WA (US); Duane A. Koehler, Vancouver, WA (US); Daniel James Magnusson, Vancouver, WA (US)

(73) Assignee: Hewlett-Packard Development Company, L.P., Spring, TX (US)

(21) Appl. No.: 17/293,615

(22) PCT Filed: Dec. 14, 2018
(86) PCT No.: PCT/US2018/065651

§ 371 Date: May 13, 2021

(51) Int. Cl. G06F 1/28; G06F 1/30; G06F 1/3206

(52) U.S. Cl. CPC G06F 1/28; G06F 1/3206; G06F 1/305

(57) ABSTRACT

In some examples, a system identifies a plurality of time periods in which a time period includes a power event and a zero power event. The system tracks a cumulative error value that is adjusted based on elimination of a power event or elimination of a zero power event in the time period. The system determines a value of a first term if a power event in the time period is eliminated, and determines a value of a second term if a zero power event in the time period is eliminated, and based on the cumulative error value, the value of the first term, and the value of the second term, decides between eliminating the power event in the time period and eliminating the zero power event in the time period.

### BACKGROUND

A system can include various components that draw power during operation of the system. In some examples, a printing system can include a print engine and heaters used to heat various zones to target temperatures. A printing system can include a two-dimensional (2D) printing system that deposits printing liquids onto a print substrate to form images on the print substrate. Alternatively, a printing system can include a three-dimensional (3D) printing system (also referred to as an additive manufacturing machine). Additive manufacturing machines are able to receive as input a computer aided design (CAD) model or other digital representation of a physical 3D object to be formed, and build, based on the CAD model, the physical 3D object. The model may be processed into layers by the additive manufacturing machine, and each layer defines a corresponding part (or parts) of the 3D object.

### BRIEF DESCRIPTION OF THE DRAWINGS

Some implementations of the present disclosure are described with respect to the following figures.

FIG. 1 is a block diagram of an arrangement that includes a pulse width modulation (PWM) controller and a credit-debit based power controller according to some examples.

FIG. 2A is a timing diagram of servo-requested power events in respective PWM time periods, according to some examples.

FIG. 2B is a timing diagram of modified power events in respective PWM time periods produced by the credit-debit based power controller, according to some examples.

FIG. 3 is a flow diagram of a process of the credit-debit based power controller, according to some examples.

FIG. 4 is a timing diagram that illustrates values of credit terms and debit terms used by the credit-debit based power controller according to some examples.

FIG. 5 is a timing diagram of a cumulative error value tracked by the credit-debit based power controller according to some examples.

FIG. 6 is a block diagram of a storage medium storing machine-readable instructions according to some examples.

FIG. 7 is a block diagram of a system according to some examples.

FIG. 8 is a flow diagram of a process according to further examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

During operation, components of a system can turn on and off, or more generally, operate at different levels. The amount of power drawn when components operate at one level can differ from the amount of power drawn when the components operate at another level. Some systems are capable of high-speed operations, in which the components of the system can be switched between different power levels (e.g., between on and off) at relatively high speeds.

Switching components of a system between different power levels causes fluctuations in the amount of power drawn from a power source, which can include an alternating current (AC) wall outlet of a home or building. The fluctuations in the amount of power drawn from the power source can cause the voltage across the output terminals of the power source (such as power transformer that supplies the AC wall outlet) to fluctuate. The fluctuations in the power voltage (across the output terminals of the power source) may be noticeable to humans if a light fixture is connected to the output terminals of the power source. Variations in the voltage can cause fluctuations in the light intensity of the light fixture. The fluctuation in light intensity of a light fixture is referred to as light flicker, which can be bothersome to some people who are sensitive to such light flicker.

A printing system can include heaters, which can consume a relatively large amount of power when activated. Examples of heaters can include heating lamps, resistive heating elements, and so forth. When the printing system is initially started, the heaters are activated to bring temperatures of various zones of the printing system to respective target temperatures. Once the temperatures of the various zones reach respective target temperatures, the printing system is considered to have reached a steady state.

During a steady-state operation of the printing system after temperatures of the various zones have reached the respective target temperatures, power to the heaters can be cycled between on and off in each cycle (that has a specified time period) of multiple cycles of operation to maintain respective target temperatures. To maintain the target temperature of a zone heated by a heater, power is applied to the heater in one portion of each cycle, while power is removed from the heater in another portion of each cycle.

The cycles during which power to heaters are switched on and off can be referred to as pulse width modulation (PWM) cycles. PWM refers to adjusting the duty cycle of a signal used to control the application of power to a component (e.g., a heater), such that a target goal (e.g., a target temperature) is achieved. The duty cycle of a signal refers to the proportion of time that the signal is on (such that power is applied to the component) and time that the signal is off in each time period of a PWM cycle. For example, a duty cycle of 40% means that the signal is on for 40% of the time period, while the signal is off for 60% of the time period. Within each time period, the duty cycle of the signal is controlled to achieve a target goal, such as a target temperature maintained by a heater.

The switching on and off of power to heaters in a printing system in respective PWM cycles can lead to power fluctuations that can cause flicker. In addition, or alternatively, the switching on and off of power to heaters in a printing system in respective PWM cycles may negatively affect power line harmonics and may result in excessive electromagnetic (EM) emissions.

A PWM cycle, or more generally, a time period can include a power event and a zero power event. A power event is an event to apply power to a component (such as a heater), and a zero power event is an event to refrain from applying power to the component. Note that there may be multiple power events within a time period, where the multiple power events are events to apply power to respective different components (such as respective different heaters). In a time period with multiple power events for respective different components, a zero power event is an event to refrain from applying power to any of the multiple components.

In accordance with some implementations of the present disclosure, to reduce the number of transitions between power events and zero power events in successive time periods (e.g., PWM cycles), a system can track a cumulative error that is adjusted based on elimination of a power event or elimination of a zero power event in a time period. Eliminating a power event refers to removing application of power represented by the power event (i.e., power indicated by the power event is not applied if the power event is eliminated). Eliminating a zero power event refers to adding an application of power to a time interval of the zero power event (i.e., power is applied to a component during the time interval of the zero power event if the zero power event is eliminated).

For a respective time period, the system can determine a value of a first term (referred to as a “debit term” further below) if a power event in the respective time period is eliminated, and determine a value of a second term (referred to as a “credit term” further below) if a zero power event in the respective time period is eliminated. Based on the cumulative error value, the value of the first term, and the value of the second term, the system can decide between eliminating the power event in the respective time period and eliminating the zero power event in the respective time period.

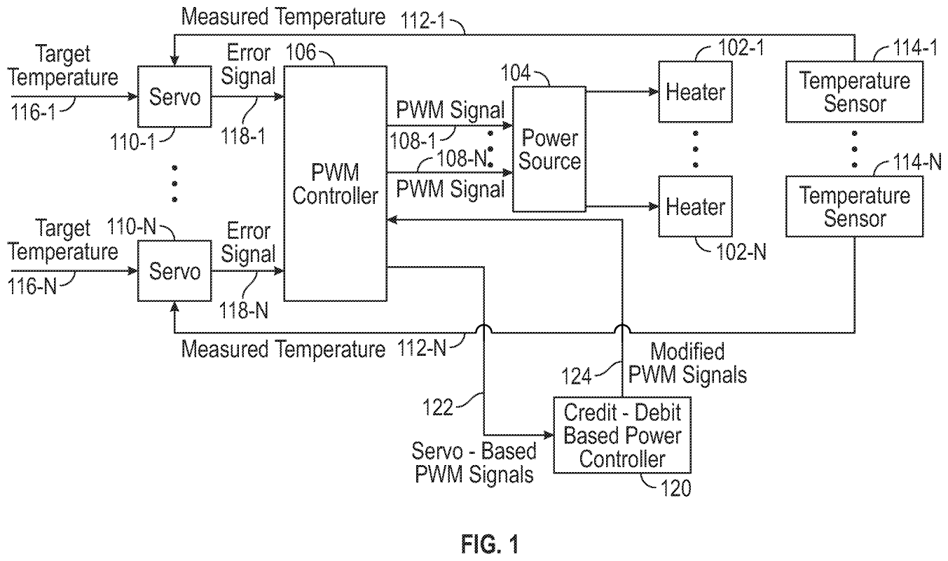

FIG. 1 is a block diagram of an example arrangement that includes heaters 102-1 and 102-N that are to be powered by a power source 104. The power source 104 can include an AC wall outlet, a battery, or any other type of power source. There can be N (N≥2) heaters in a system, such as a printing system or other type of system. In other examples, a system can include just one heater.

Although reference is made to heaters as examples of components that are powered by a power source, it is noted in other examples, other types of components can be powered by the power source 104.

The arrangement of FIG. 1 also includes a PWM controller 106 that provides PWM signals 108-1 to 108-N to the power source 104. The PWM signal 108-1 is used to control application of power to the heater 102-1, while the PWM signal 108-N is used to control the application of power by the power source 104 to the heater 102-N. In some examples, the number of PWM signals provided to the power source 104 is based on the number of heaters to be powered by the power source 104.

A PWM signal can vary between an active state (e.g., logic high) and an inactive state (e.g., logic low). When a PWM signal 108-i (i=1 . . . N) is active, then the power source 104 applies power to the corresponding heater 102-i, and if the PWM signal 108-i is inactive, then the power source 104 does not apply power to the corresponding heater 102-i. Each PWM signal 108-i can transition between on and off at a duty cycle set by the PWM controller 106 to maintain a target goal, such as a target temperature to be provided by the respective heater 102-i.

The PWM controller 106 produces PWM signals based on error signals received from servos 110-1 to 110-N. The servo 110-1 receives a measured temperature 112-1 from a temperature sensor 114-1 that measures a temperature of a zone that is proximate the heater 102-1 (e.g., a zone to be heated by the heater 102-1). The servo 110-1 also receives a target temperature 116-1, which is the target temperature of the zone associated with the heater 102-1. The servo 110-1 compares the measured temperature 112-1 to the target temperature 116-1, and produces an error signal 118-1 based on the difference between the measured temperature 112-1 and the target temperature 116-1. The PWM controller 106 produces a servo-based PWM signal for the heater 102-1 based on the error signal 118-1. The duty cycle of the servo-based PWM signal is adjusted based on the error signal 118-1 (e.g., the duty cycle is increased to apply more power to the heater 102-1 if the error signal 118-1 indicates the measured temperature 112-1 is less than the target temperature 116-1, and the duty cycle is decreased to apply less power to the heater 102-1 if the error signal 118-1 indicates the measured temperature 112-1 is greater than the target temperature 116-1).

Similarly, the servo 110-N receives a measured temperature 112-N from a temperature sensor 114-N that measures a temperature of a zone proximate the heater 102-N. The servo 110-N also receives a target temperature 116-N. Based on a difference between the measured temperature 112-N and the target temperature 116-N, the servo 110-N produces an error signal 118-N that is used by the PWM controller 106 to produce a servo-based PWM signal for the heater 102-N.

In some examples where modification of power events and zero power events according to some implementations of the present disclosure is not performed, the servo-based PWM signals generated by the PWM controller 106 based on the error signals 118-1 to 118-N can be provided as the PWM signals 108-1 to 108-N to control power applied to the heaters 102-1 to 102-N. However, in accordance with some implementations of the present disclosure, instead of providing the servo-based PWM signals directly to the power source 104, a credit-debit based power controller 120 is used to possibly modify the servo-based PWM signals (122) so that the PWM signals 108-1 to 108-N provided by the PWM controller 106 to the power source 104 are based on computations of the credit-debit based power controller 120.

In some examples, the credit-debit based power controller 120 is separate from the PWM controller 106. In fact, in some examples, the credit-debit based power controller 120 may be in a system that is separate from the system including the PWM controller 106, the power source 104, the heaters 102-1 to 102-N, the temperature sensors 114-1 to 114-N, and the servos 110-1 to 110-N. In other examples, the credit-debit based power controller 120 can be part of the PWM controller 106.

As used here, a “controller” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, an “controller” can refer to a combination of a hardware processing circuit and machine-readable instructions (software and/or firmware) executable on the hardware processing circuit.

As shown in FIG. 1, the PWM controller 106 provides servo-based PWM signals 122 to the credit-debit based power controller 120. The credit-debit based power controller 120 can modify the servo-based PWM signal 122, to produce modified PWM signals 124 that are provided back to the PWM controller 106 (or alternatively, to the power source 104). The PWM signals 108-1 to 108-N provided to the power source 104 for controlling respective power applied to the heaters 102-1 to 102-N can be the modified PWM signals 124 or can be based on the modified PWM signals 124.

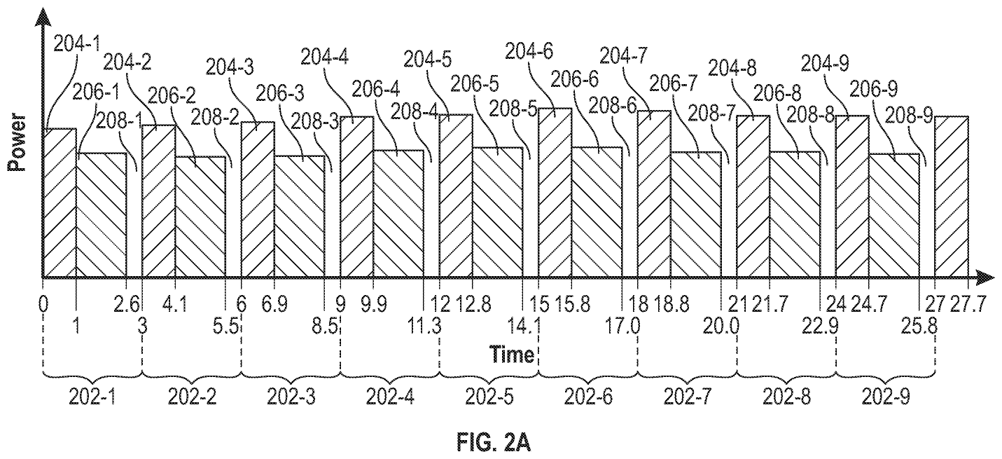

FIG. 2A shows a timing diagram of power events in respective PWM cycles (also referred to as PWM time periods) 202-1 to 202-9. The horizontal axis represents time (such as in units of seconds), and the vertical axis represents power.

In the example of FIG. 2A, each PWM time period 202-j (j=1, 2, . . . ) includes a power event 204-j for the heater 102-j, and a power event 206-j for the heater 102-N. Each PWM time period 202-j also includes a zero power event 208-j.

For example, in the PWM time period 202-1, a power event 204-1 represents an amount of power (as represented by the vertical axis in FIG. 2A) applied to the heater 102-1 in a time duration represented by the width of the power event 204-1, and a power event 206-1 represents an amount of power applied to the heater 102-N in a time duration represented by the width of the power event 206-1. In addition, the PWM time period 202-1 includes a zero power event 208-1 having a time duration represented by the width of the zero power event 208-1. During the time duration of the zero power event 208-1, no power is applied to any of the heaters 102-1 to 102-N.

The power events and zero power events in respective PWM time periods as shown in FIG. 2A are derived based on the servo-based PWM signals 122 of FIG. 1. The servo-based PWM signals 122 provide indications of when power is applied to the respective heaters 102-1 to 102-N, and when power is not applied to the respective heaters 102-1 to 102-N. From the servo-based PWM signals 122, the amount of time that each heater 102-1 to 102-N is powered in each PWM time period can be derived, and the amount of time when no power is applied to any heater in each PWM time period can be derived.

In the PWM time period 202-1, the power event 204-1 occupies a time from 0 to 1 (time length of 1), while the power event 206-1 occupies a time from 1 to 2.6 (time length of 1.6). The zero power event 208-1 extends from 2.6 to 3 (time length of 0.4). It is assumed that each PWM time period lasts 3 seconds, in the example.

As can be seen from the timing diagram of FIG. 2A, there are a relatively large number of transitions between power events and zero power events, i.e., there is a transition in each PWM time period. A large number or high frequency of power transitions can lead to excessive flicker that can exceed regulatory rules or policies and other issues as explained above.

In accordance with some implementations of the present disclosure, the credit-debit based power controller 120 can modify a sequence of power events and zero power events to reduce the number of transitions that are present in the PWM time periods.

An example of such a modified sequence is shown in the timing diagram of FIG. 2B. As shown in FIG. 2B, based on processing applied by the credit-debit based power controller 120, power events and zero power events can be selectively eliminated in corresponding PWM time periods. For example, in the PWM time period 202-1, the zero power event 208-1 of FIG. 2A has been eliminated, and the power event 206-1 has been extended to become 206-1E in FIG. 2B. Similarly, in the PWM time period 202-2, the zero power event 208-2 has been eliminated, and the power event 206-2 shown in FIG. 2A has been extended to become 206-2E in FIG. 2B.

Extending the power events 206-1 and 206-2 in the PWM time periods 202-1 and 202-2 effectively borrows some amount of the power that has been or would be applied in subsequent (or other) PWM time periods, for application in the PWM time periods 202-1 and 202-2 instead of the subsequent (or other) time periods. Since the application of power has been borrowed from a subsequent (or other) PWM time period(s), a corresponding power event would have to be eliminated in a subsequent (or other) PWM time period(s), to avoid applying too much power to the respective heater. Thus, in the PWM time period 202-3, the power event 206-3 that was present in the PWM time period 202-3 of FIG. 2A is eliminated, such that a longer zero power event 208-3E is present in the PWM time period 202-3.

As further shown in FIG. 2B, in each of PWM time periods 202-4, 202-5, 202-7, and 202-9, corresponding zero power events 208-4, 208-5, 208-7, and 208-9 have been eliminated, and the respective power events 206-4E, 206-5E, 206-7E, and 206-9E have been extended. In each of PWM time periods 202-6 and 202-8, corresponding power events 206-6 and 206-8 have been eliminated, and the zero power events 208-6E and 208-8E have been extended.

Although FIG. 2B shows the selective extension or elimination of power events 206-j for the heater 102-N, it is noted in other examples the power events 204-j for the heater 102-1 can be extended or eliminated.

The credit-debit based power controller 120 updates a cumulative error to track borrowing and debiting power from and to PWM time periods. Borrowing power from a subsequent PWM time period refers to applying, in a current PWM time period, power that would have been applied in a subsequent PWM time period. Debiting power in a given PWM time period refers to eliminating the application of power in the given PWM time period due to borrowing of power from a PWM time period in a prior or subsequent PWM time period.

The value of the cumulative error is adjusted as power events and zero power events are eliminated. For example, eliminating a zero power event would lead to any increase in the amount of power applied in a current PWM time period, such that the credit-debit based power controller 120 increases the cumulative error value. On the other hand, eliminating a power event would reduce the amount of power applied in a current PWM time period, such that the credit-debit based power controller 120 decreases the cumulative error value. In other examples, the cumulative error can be adjusted in different ways based on elimination of a zero power event or a power event. In subsequent discussions, it is assumed that eliminating a zero power event would lead to an increase of the value of the cumulative error, while eliminating a power event would lead to a reduction of the value of the cumulative error.

Stated differently, eliminating a zero power event such that power from a subsequent PWM time period is applied in a prior PWM time period is referred to as a “credit.” On the other hand, eliminating a power event in a PWM time period due to borrowing of power from a prior or subsequent PWM time period is referred to as a “debit.”

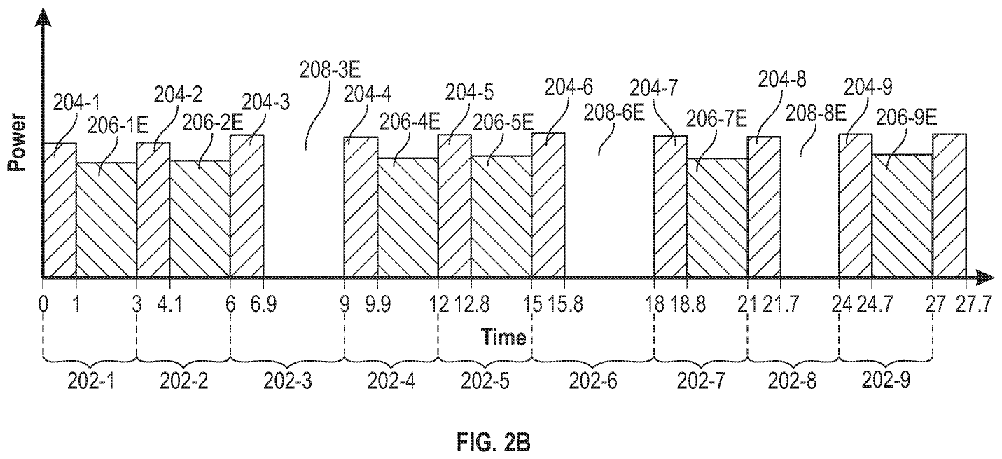

FIG. 3 is a flow diagram of a process performed by the credit-debit based power controller 120, according to some examples. The credit-debit based power controller 120 maintains (at 302) a cumulative error whose value is based on credits and debits applied due to elimination of zero power events and power events, respectively. More generally, the cumulative error represents a cumulative value that is based on a difference of power actually applied less the power requested (where the power requested is based on error signals from the servos 110-1 to 110-N of FIG. 1).

The cumulative error value is updated as power events and zero power events are eliminated in successive PWM time periods.

The credit-debit based power controller 120 receives (at 304) information indicating power events and zero power events in respective PWM time periods. The information is based on servo-based PWM signals 122 (FIG. 1) produced by the PWM controller 106 of FIG. 1, for example.

The process of FIG. 3 is applied for each PWM time period of the multiple PWM time periods indicated by the received information in an iterative manner. In other words, the process iterates (at 306) through each of the multiple PWM time periods. For a current PWM time period under consideration in the iterative process, the credit-debit based power controller 120 calculates (at 308) a value of a credit term if a zero power event in the current PWM time period is eliminated. The credit term value represents an amount of power that would be increased in the current PWM time period if the zero power event of the current PWM time period is eliminated (in other words, power for a subsequent PWM time period is borrowed and applied in the current PWM time period).

For example, in FIG. 2A, if the zero power event 208-1 is eliminated in the PWM time period 202-1, then the value of the credit term is 0.4, since the time length of the zero power event 208-1 is 0.4. Note that the 0.4 value of the credit term is a relative value, and does not represent the absolute amount of power. In the ensuing discussion, the value of a credit term is expressed as a value that is based on the time length of an eliminated zero power event, while the value of a debit term is calculated based on the time length of an eliminated power event.

The credit-debit based power controller 120 further calculates (at 310) a value of a debit term if a power event of the current PWM time period is eliminated. For the PWM time period 202-1 in FIG. 2A, if the power event 206-1 is eliminated, then the value of the debit term for the eliminated power event 206-1 is 1.6, which is the time length of the power event 206-1.

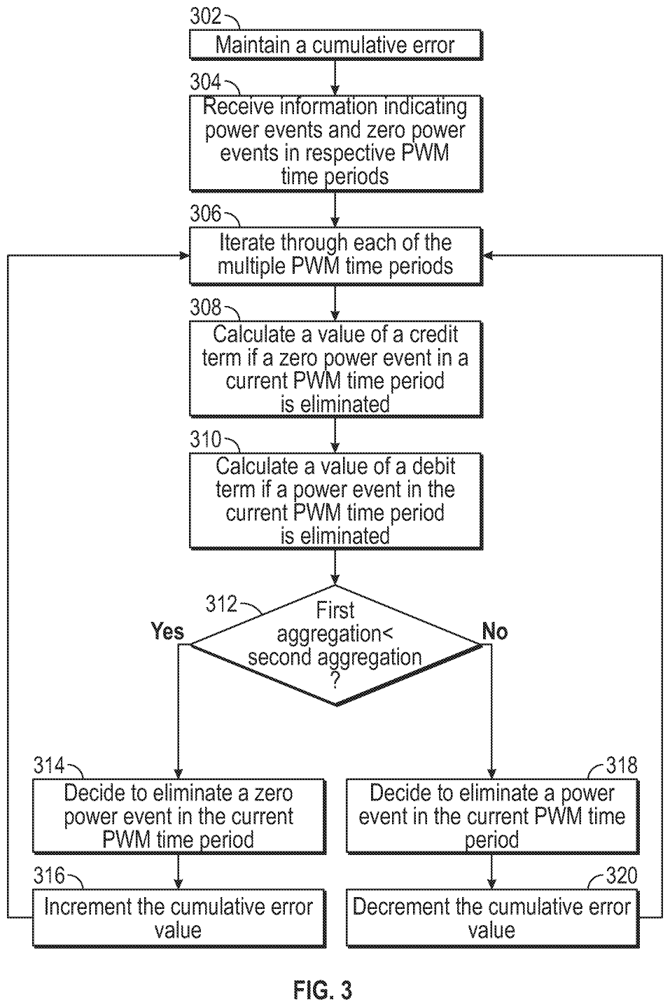

FIG. 4 is a timing diagram that illustrates a series of credit and debit values in successive PWM time periods 202-1 to 202-9 based on computations of tasks 308 and 310 in FIG. 3. In FIG. 4, a credit term value of 0.4 and a debit term value of 1.6 are shown for the PWM time period 202-1. The debit term values are shown with negative values to indicate that a debit term value would cause the cumulative error value to decrease (due to elimination of a power event).

The credit-debit based power controller 120 makes a determination of whether to eliminate a zero power event or eliminate a power event in the current PWM time period based on comparing (at 312) a first aggregation of the cumulative error value and the credit term value, with a second aggregation of the cumulative error value and the debit term value. For example, the first aggregation is the absolute value of a sum of the cumulative error value and the credit term value, and the second aggregation is the absolute value of a sum between the cumulative error value and the debit term value (which is negative). If the value of the first aggregation is less than the value of the second aggregation, as determined (at 312), the credit-debit based power controller 120 decides (at 314) to eliminate a zero power event in the current PWM time period (in other words, the time duration of the zero power event is filled in with the application of power for the heater 102-N, for example).

In response to deciding to eliminate the zero power event in the current PWM time period, the credit-debit based power controller 120 increments (at 316) the cumulative error value based on the amount of power added due to filling in the time interval of the eliminated zero power event with power. For example, the credit-debit based power controller 120 adds the value of the credit term value to the cumulative error value to produce an updated cumulative error value.

If the value of the first aggregation is not less than the value of the second aggregation, as determined (at 312), then the credit-debit based power controller 120 decides (at 318) to eliminate a power event in the current PWM time period, and the credit-debit based power controller 120 decrements (at 320) the cumulative term value by the debit term value.

Although task 312 of FIG. 3 shows a determination of whether the value of the first aggregation is less than the value of the second aggregation, it is noted that in other examples, the credit-debit based power controller 120 can decide to eliminate the zero power event in the current PWM time period in response to a first relationship between the values of the first aggregation and the second aggregation, and decide to eliminate the power event in the current PWM time period in response to a different second relationship between the values of the first aggregation and the second aggregation.

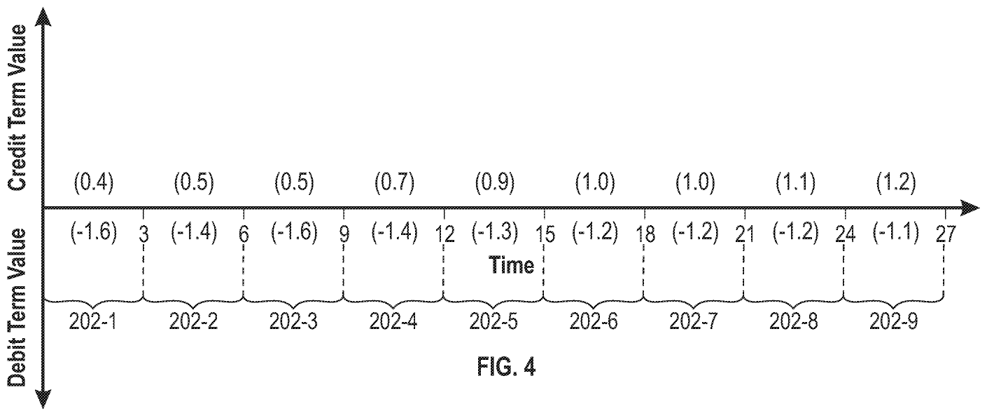

FIG. 5 is a timing diagram that shows the value of the cumulative error in successive PWM time periods 202-1 to 202-9. For example, assuming that the cumulative error value begins with zero, then a comparison of 0.4 (credit term value for PWM time period 202-1) and 1.6 (debit term value for PWM time period 202-1) will indicate that 0.4 is less than 1.6 (i.e., the credit term value is less than the debit term value), in which case the credit-debit based power controller 120 would decide to eliminate the zero power event 208-1 in the PWM time period 202-1. In this case, the cumulative term value (initially at zero in the example) is incremented by the value of the credit term value (e.g., 0.4 for the PWM time period 202-1), to produce an updated cumulative term value of 0.4 in the PWM time period 202-1 in FIG. 5.

The cumulative error value is further increased in the PWM time period 202-2 since the decision for the PWM time period 202-2 would also be to eliminate the zero power event in the PWM time period 202-2, based on the determination (at 312). However, in the PWM time period 202-3, the decision would be to eliminate a power event, in which case the cumulative error value is decreased, as shown in FIG. 5 for PWM time period 202-3.

This process continues for the successive PWM time periods as shown in FIG. 5.

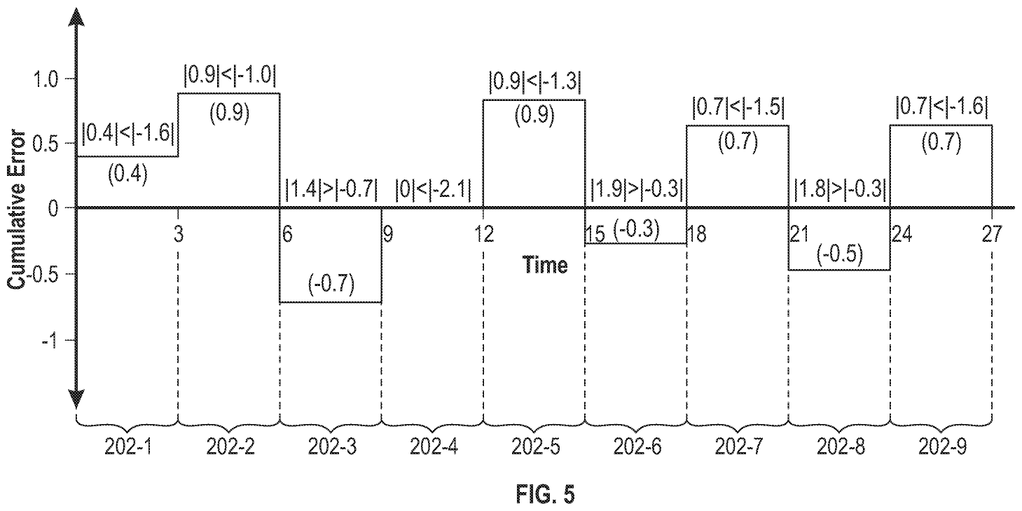

FIG. 6 is a block diagram of a non-transitory machine-readable or computer-readable storage medium 600 storing machine-readable instructions for controlling power, the machine-readable instructions upon execution causing a system to perform various tasks. The machine-readable instructions can be part of the credit-debit based power controller 120, for example.

The machine-readable instructions include time period identification instructions 602 to identify a plurality of time periods, where each of some of the time periods includes a power event and a zero power event. As used here, “some” of the time periods can refer to one of the time periods, a subset of the time periods, or all of the time periods. Note that it is possible that a time period may be without a power event or a zero power event. The identification can be based on servo-based PWM signals (e.g., 122) provided by a PWM controller (e.g., 106 in FIG. 1).

The machine-readable instructions further include cumulative error tracking instructions 604 to track a cumulative error value that is adjusted based on elimination of a power event or elimination of a zero power event in a time period of the plurality of time periods.

The machine-readable instructions further include instructions 606 and 608 to perform tasks for a given time period of the plurality of time periods. The instructions 606 are first and second term determination instructions to determine a value of a first term (debit term) if a power event in the given time period is eliminated, and determine a value of a second term (credit term) if a zero power event in the given time period is eliminated.

The instructions 608 are power event elimination decision instructions to, based on the cumulative error value, the value of the first term, and the value of the second term, decide between eliminating the power event in the given time period and eliminating the zero power event in the given time period. For example, the decision can be based on the criterion 312 in FIG. 3.

In response to deciding to eliminate the zero power event in the given time period, the machine-readable instructions can extend the power event or another power event in the given time period.

In response to deciding to eliminate the power event in the given time period, the machine-readable instructions can extend the zero power event in the given time period.

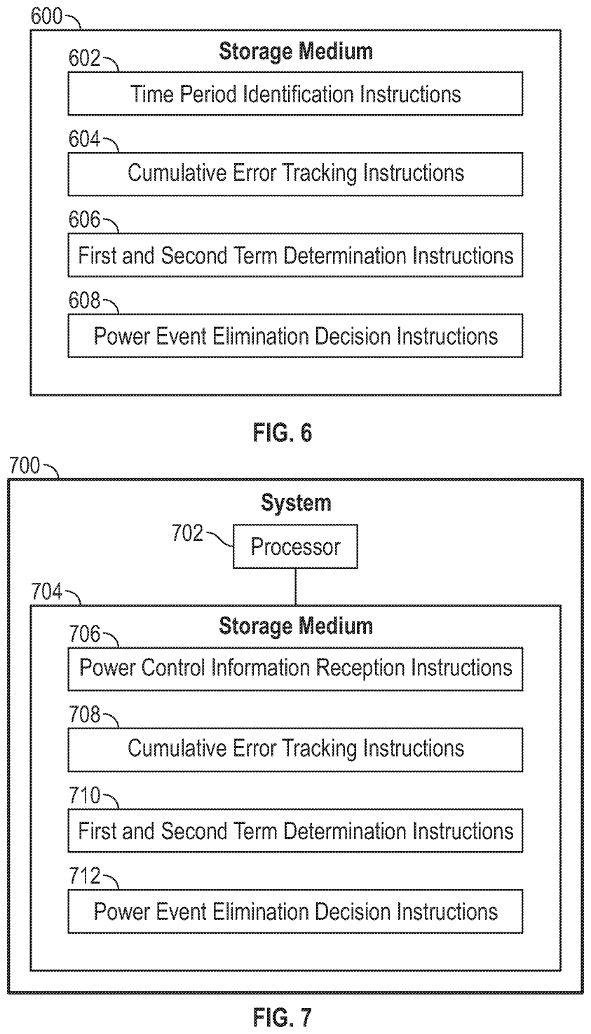

FIG. 7 is a block diagram of a system 700 that includes a hardware processor 702 (or multiple hardware processors). A hardware processor can include a microprocessor, a core of a multi-core microprocessor, a microcontroller, a programmable integrated circuit, a programmable gate array, a digital signal processor, or another hardware processing circuit.

The system 700 further includes a storage medium 704 storing machine-readable instructions executable on the hardware processor 702 to perform various tasks. Machine-readable instructions executable on a hardware processor can refer to the instructions executable on a single hardware processor or the instructions executable on multiple hardware processors.

The machine-readable instructions include power control information reception instructions 706 to receive information generated by a PWM controller (e.g., 106 in FIG. 1) relating to power control of a component, the information indicating a plurality of time periods where each of some of the time periods includes a power event and a zero power event.

The machine-readable instructions further include cumulative error tracking instructions 708 to track a cumulative error value that is adjusted based on elimination of a power event or elimination of a zero power event in a time period of the plurality of time periods.

The machine-readable instructions further include instructions 710 and 712 to perform tasks for a given time period of the plurality of time periods.

The instructions 710 include first and second term determination instructions to determine a value of a first term if a power event in the respective time period is eliminated, and determine a value of a second term if a zero power event in the respective time period is eliminated.

The instructions 712 include power event elimination decision instructions to, based on the cumulative error value, the value of the first term, and the value of the second term, decide between eliminating the power event in the respective time period and eliminating the zero power event in the respective time period.

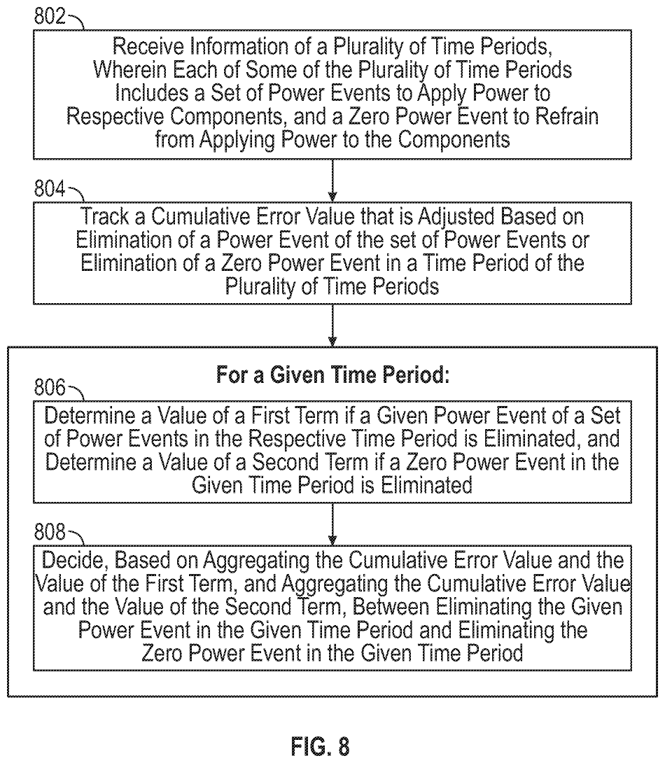

FIG. 8 is a flow diagram of a process according to further examples. The process of FIG. 8 includes receiving (at 802) information of a plurality of time periods where each of some of the time periods includes a set of power events to apply power to respective components, and a zero power event to refrain from applying power to the components.

The process further includes tracking (at 804) a cumulative error value that is adjusted based on elimination of a power event of the set of power events or elimination of a zero power event in a time period of the plurality of time periods.

The process further performs tasks 806 and 808 for a given time period of the plurality of time periods. Task 806 determines a value of a first term if a given power event of a set of power events in the given time period is eliminated, and determines a value of a second term if a zero power event in the given time period is eliminated.

Task 808 decides, based on aggregating the cumulative error value and the value of the first term, and aggregating the cumulative error value and the value of the second term, between eliminating the given power event in the given time period and eliminating the zero power event in the given time period.

The storage medium 600 (FIG. 6) or 704 (FIG. 7) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disc (CD) or a digital video disc (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions for controlling power, the instructions upon execution causing a system to:
identify a plurality of time periods in which a time period of the plurality of time periods includes a power event and a zero power event;
track a cumulative error value that is adjusted based on elimination of a power event or elimination of a zero power event in the time period; and
determine a value of a first term if a power event in the time period is eliminated, and determine a value of a second term if a zero power event in the time period is eliminated, and
based on the cumulative error value, the value of the first term, and the value of the second term, decide between eliminating the power event in the time period and eliminating the zero power event in the time period.

2. The non-transitory machine-readable storage medium of claim 1, wherein the power event in the time period comprises an event to apply power to a component, and the zero power event in the time period comprises an event to refrain from applying power to the component.

3. The non-transitory machine-readable storage medium of claim 1, wherein the instructions upon execution cause the system to:
in response to deciding to eliminate the zero power event in the time period, extend the power event or another power event in the time period.

4. The non-transitory machine-readable storage medium of claim 1, wherein the instructions upon execution cause the system to:
in response to deciding to eliminate the power event in the time period, extend the zero power event in the time period.

5. The non-transitory machine-readable storage medium of claim 1, wherein the instructions upon execution cause the system to:
receive information of the plurality of time periods based on information from a controller that controls duty cycles of power provided to a component based on a target temperature and a measured temperature of a zone proximate the component.

6. The non-transitory machine-readable storage medium of claim 1, wherein the instructions upon execution cause the system to:
in response to deciding to eliminate the zero power event in the time period, update the cumulative error value to indicate that power has been added in the time period.

7. The non-transitory machine-readable storage medium of claim 1, wherein the instructions upon execution cause the system to:
in response to deciding to eliminate the power event in the time period, update the cumulative error value to indicate that power has been removed in the time period.

8. The non-transitory machine-readable storage medium of claim 1, wherein the instructions upon execution cause the system to:
in response to deciding to eliminate the zero power event in the time period or eliminate the power event in the time period, update the cumulative error value; and
for a further time period of the plurality of time periods:
determine a value of the first term for the further time period if a power event in the further time period is eliminated, and determine a value of the second term for the further time period if a zero power event in the further time period is eliminated, and
based on the updated cumulative error value, the value of the first term for the further time period, and the value of the second term for the further time period, decide between eliminating the power event in the further time period and eliminating the zero power event in the further time period.

9. The non-transitory machine-readable storage medium of claim 1, wherein the instructions upon execution cause the system to, for the time period:
compare a first aggregation of the cumulative error value and the value of the first term with a second aggregation of the cumulative error value and the value of the second term,
wherein deciding between eliminating the power event in the time period and eliminating the zero power event in the time period is based on the comparing.

10. The non-transitory machine-readable storage medium of claim 9, wherein the first aggregation of the cumulative error value and the value of the first term is based on an absolute value of a difference between the cumulative error value and the value of the first term, and the second aggregation of the cumulative error value and the value of the second term is based on an absolute value of a sum of the cumulative error value and the value of the second term.

11. The non-transitory machine-readable storage medium of claim 9, wherein the instructions upon execution cause the system to:
decide to eliminate the zero power event in the time period in response to a first relationship between the first aggregation and the second aggregation; and
decide to eliminate the power event in the time period in response to a different second relationship between the first aggregation and the second aggregation.

12. A system comprising:
a processor; and
a non-transitory storage medium storing instructions for power control executable on the processor to:
receive information generated by a pulse width modulation (PWM) controller relating to power control of a component, the information indicating a plurality of time periods, wherein a time period of the plurality of time periods includes a power event and a zero power event, the power event comprising an event to apply power to the component, and the zero power event comprising an event to refrain from applying power to the component;
track a cumulative error value that is adjusted based on elimination of a power event or elimination of a zero power event in the time period; and
determine a value of a first term if a power event in the time period is eliminated, and determine a value of a second term if a zero power event in the time period is eliminated, and
based on the cumulative error value, the value of the first term, and the value of the second term, decide between eliminating the power event in the time period and eliminating the zero power event in the time period.

13. The system of claim 12, wherein the instructions are executable on the processor to:
decide to eliminate the power event in the time period if a first aggregation of the cumulative error value and the value of the first term has a first relationship with respect to a second aggregation of the cumulative error value and the value of the second term; and
decide to eliminate the zero power event in the time period if the first aggregation has a different second relationship with respect to the second aggregation.

14. A method of power control performed by a system comprising a hardware processor, comprising:
receiving information of a plurality of time periods, wherein each of some of the plurality of time periods includes a set of power events to apply power to respective components, and a zero power event to refrain from applying power to the components;
tracking a cumulative error value that is adjusted based on elimination of a power event of the set of power events or elimination of a zero power event in a time period of the plurality of time periods; and
for a respective time period of the plurality of time periods:
determining a value of a first term if a given power event of a set of power events in the respective time period is eliminated, and determining a value of a second term if a zero power event in the respective time period is eliminated, and
based on aggregating the cumulative error value and the value of the first term, and aggregating the cumulative error value and the value of the second term, deciding between eliminating the given power event in the respective time period and eliminating the zero power event in the respective time period.

15. The method of claim 14, further comprising:
in response to deciding to eliminate the given power event in the respective time period, extending the zero power event in the respective time period; and
in response to deciding to eliminate the zero power event in the respective time period, extending the given power event in the respective time period.
